(19) United States
(12) Patent Application Publication
(10) Pub. No.: US 2004/0185148 A1
(43) Pub. Date: Sep. 23, 2004

(54) Extrusion processing of distillers grains with solubles and the products thereof

(76) Inventor: Nabil W. Said, Windsor Heights, IA (US)

Correspondence Address: DAVIS, BROWN, KOEHN, SHORS & ROBERTS, P.C., THE FINANCIAL CENTER, 666 WALNUT STREET, SUITE 2500, DES MOINES, IA, 50309-3993, US

(21) Appl. No.: 10/391,722

(22) Filed: Mar. 19, 2003

(51) Int. Cl. A23C 9/12

(52) U.S. Cl. 426/53

(57) ABSTRACT

A process for preparing a feed from the byproducts or coproducts of dry corn milling, such as dried corn distiller's solubles, that is suitable for feeding to both monogastric and ruminant animals. The partially dried coproducts are mixed with an additive that improves the amino acid profile, reduces the fiber content and improves the bioavailability of feed components of the coproducts and processed through an extruder. Suitable additives include oilseeds and their byproducts, legumes and their by products, and animal byproducts. The resulting animal feed has a reduced moisture content, an extended product life and is palatable to swine.

### BACKGROUND OF THE INVENTION

The invention relates generally to animal feed products and, more specifically, to a method of producing an animal feed product through extrusion processing of dried distiller's grains with solubles and an additive which improves the amino acid profile, reduces the fiber content and improves the bioavailability of feed components of the dried distiller's grains with solubles. Suitable additives include oilseeds and their byproducts, legumes and their by products, and animal byproducts.

Dried distiller's grains (DDG) and condensed distiller's solubles (CDS) are the major by-products (sometimes now referred to as coproducts) of the process of producing alcohol from grains, most importantly corn. In the corn dry milling process, one bushel of corn produces approximately 2.6 gallons of ethanol, 17 pounds of dried distiller's grains, and 18 pounds of carbon dioxide. Recently, there has been a dramatic increase in the demand for alcohol from renewable resources as an alternative to fossil fuels. This has lead to an increase in the byproducts of the distillation process. Dried distiller's grains and corn distiller's solubles are either sold separately or as a combination product known as dried distiller's grains with solubles (DDGS) which is produced when part of the corn distiller's solubles is dried on dried distiller's grains. It is estimated that the North American production of dried distiller's grains solubles will double between 2000 and 2005. The process of drying constitutes the last stage of the process where the products are dehydrated to a moisture level of about 7 to 13%.

The dried distiller's grains and dried distiller's grains solubles or corn distiller's solubles, from an animal feed stand point, are low in starch but high in fat, protein, fiber, and phosphorus. While high in overall protein, the quality of the protein is rather poor. For this reason, the dried distiller's grains, dried distiller's grains with solubles are being sold mainly for ruminant animal feed. Dehydration is generally necessary in order to extend the shelf-life of the products beyond a few days. The dehydration process, however, is energy-intensive and adds considerably to the cost of production. In addition, the mycotoxin content is typically 2 to 3 times that of corn. While a market has developed for these products as an additive to rations for ruminant animals, they have not been used widely for the feeding of monogastric animals due primarily to the inability of monogastric animals to utilize the relatively poor amino acid profile, the high fiber content, and the inconsistent quality of the existing products.

There is, accordingly, a need to process the distiller's grains products to correct the deficiencies of the products for monogastric animals and to increase the bioavailability of the nutrients and feed value to monogastric animals, thereby increasing the value of these products.

There is also a need to reduce the amount of energy required to produce a viable commercial product.

### SUMMARY OF THE INVENTION

The invention is a method of creating an animal feed product for both monogastric and ruminant animals from a combination of distiller's grains byproducts or coproducts and an additive that improves the amino acid profile, reduces the fiber content and improves the bioavailability of feed components of the dried distiller's grains with solubles. Suitable additives include oilseeds and their byproducts, legumes and their by products, and animal byproducts. The additive and distiller's grain byproducts are combined and processed in an extruder, optionally an extruder provided with a steam preconditioner, which conditions the feed product, destroys anti-nutritive components, homogenizes and sterilizes the feed product, and subjects it to a high heat. Upon discharge from the extruder, approximately one-half of the moisture of the feed product is flashed off, leaving a high-protein, palatable animal feed product that is suitable for feeding to monogastric and ruminant animals, economical, easy flowing and has an extended product life.

The process adds value to the dry milling process in terms of increasing efficiency by reducing the need to completely dry the distiller's grains and solubles along with adding value to the nutritional profile of these products in a way that will widen their use in animal feed including monogastric animals.

An object of the present invention is to produce an animal feed by co-extruding a coproduct of the dry corn milling process with an additive which improves the amino acid profile, reduces the fiber content and improves the bioavailability of feed components of the coproduct,

Another object of the present invention is to produce an animal feed using a coproduct of the dry corn milling process that is easy flowing, has an extended shelf life, reduced mycotoxin content, consistent quality, and will serve to stabilize the price and increase the value of the coproduct.

A further object of the invention is to provide a ruminant feed produced using a coproduct of the dry corn milling process that has improved by-pass protein and improved intestinally absorbed dietary protein.

These and other objects of the invention will be appreciated by those of skill in the art upon a review of this specification, the associated drawing and the appended claims.

### BRIEF DESCRIPTION OF THE DRAWING

FIG. 1 is a schematic diagram of a typical corn dry milling process which has been modified by the process of the present invention.

### DETAILED DESCRIPTION OF A PREFERRED EMBODIMENT

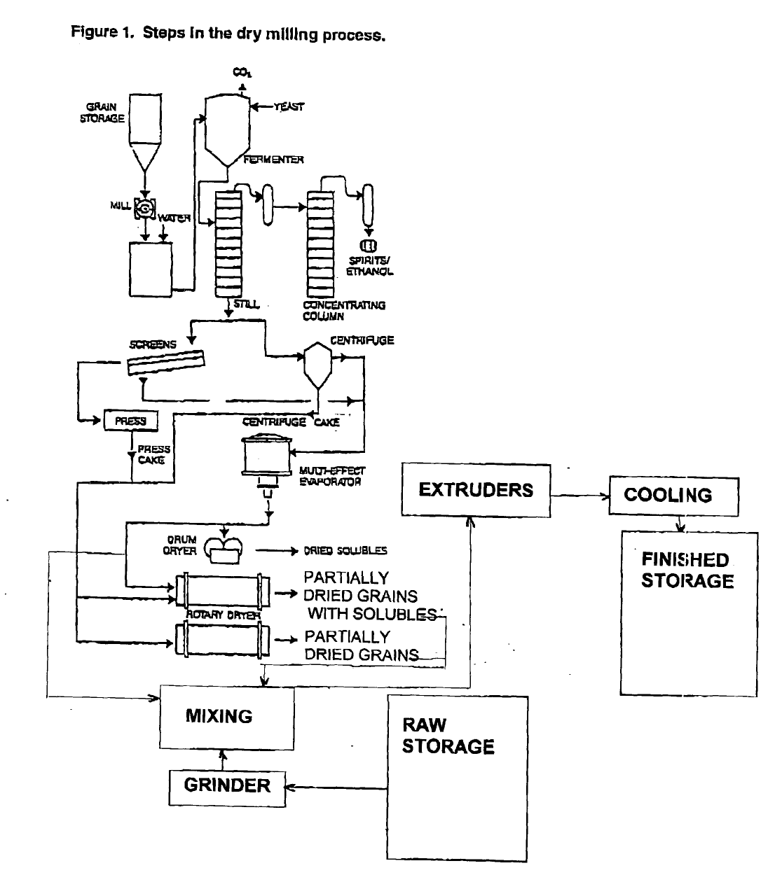

Illustrated in FIG. 1 is a schematic diagram of a typical dry corn milling process. Grain from the grain storage bin 12 is processed in a mill and transferred to a tank 14 where it is mixed with water. The mixture is transferred to a fermentation tank 16 and yeast is added. During fermentation, the yeast converts carbohydrates in the grain to ethanol and carbon dioxide. Upon completion of fermentation, the contents of the fermentation tank 16 are transferred to a still 18 which evaporates off the ethanol. The ethanol is concentrated in a concentrating column 20 and is then suitable for sale.

The remaining contents of the still are sent though a centrifuge 22 that divides the liquid and solid components. The solid components are sieved at 24 and the solids retained on the screen 24 are combined with the retentate from the centrifuge 22 and are pressed at 26 into press cake which is transferred to a rotary dryer 28. The liquid fraction from the centrifuge 22 and the filtrate from the screen 24 are combined and sent to an evaporator 30. The output of the evaporator 30 may either be dried in a drum dryer 32 to create dried distiller's solubles or may be combined with the press cake and dried in a rotary dryer 34 to create partially dried distiller's grains with solubles. In the typical dry corn milling process, the dried distiller's grains and dried distiller's grains solubles are dried to a moisture content of approximately 7 to 13% by weight.

The present invention further processes the outputs of the dry corm milling process. An additive, for example raw soybeans, are stored in a storage container 36 and are ground in a grinder 38 and then combined with one or more of the dried distiller's grain products in a mixer 40. Other additives may also be used; suitable additives include but are not limited to oilseeds and byproducts of oilseeds, legumes and byproducts of legumes, byproducts of cereal grains, and animal byproducts. Additives comprise, more specifically, soybeans, canola seed, rapeseed, cotton seed, palm kernels, flaxseed, linseed, sunflower seed, soybean meal, cottonseed meal, expelled soybean meal, corn gluten meal, fish meal, poultry byproduct meal, meat and bone meal, and feather meal. The additives can either be used singly or in combination. The mixture is transferred to an extruder 42, which may optionally include a steam preconditioner. The output of the extruder is processed through a cooler 44 and then may be packaged or stored.

The dried distiller's grains and dried distiller's grains solubles will be only partially dehydrated as opposed to the current procedure of drying to approximately 10% moisture. The ratio of the amount of oil seed to dried distiller's grains and DDGS will be determined based on the required nutritional profile of the animal feed product. The additive ingredients are metered into the mixer 40 with the dried distiller's grains and preferably with the solubles so that the moisture content of the mixture falls within the range of between about 10% and about 30% and preferably between about 18% and about 20%.

### EXAMPLE 1

### Production Processes

Raw soybeans were ground to between about 1400 and about 1600 microns which is the approximate particle size of the dried distiller's grains. The dried distiller's grains with solubles and raw soybeans were mixed at a 50/50 ratio and introduced to the extruder with and without the use of the pre-conditioner. The range of processing temperature in the extruder is measured at the last chamber of the extruder. The processing temperature will depend on the additive ingredient used to add value to the dried distiller's grains and dried distiller's grains solubles. In general, it should fall between about 220° F. and about 375° F., and preferably between about 320° F. and about 350° F. The moisture content of the mix prior to extrusion will fall between about 5 and about 30%, and preferably between about 20% and about 30%, based on whether or not a dry steam and water will be used through the pre-conditioner and the amount of corn distiller's solubles used the mix. The final product should be cooled to within ±10° C. of the plant ambient temperature before storage.

1. Extrusion of Commercial Dried Distillers Grains. When the steam or pre-conditioner is not used, water was added to the 50/50 mix of raw soybeans/dried distiller's grains to adjust the total moisture to 18% prior to extrusion. An Insta Pro Model 2500 Dry Extruder (Insta-Pro International, Des Moines, Iowa) was used with the following set-up:

Barrel Configuration: Single flight screws with 11R-11R-11R-11 steam locks.

Feeder Type: Side feeder.

Shaping Attachment: Nose cone size 5/16 inch.

Extruder Amps: 140.

Side Feeder Rate: 45 R.P.M.'s.

Extruder temperature at the last chamber=320° F.

Production rate: 3336 lbs. per hour.

Moisture content of extruded 50/50 dried distiller's grains/soybeans=9%.

2. Extrusion of Commercial Dried Distillers Grains (Using a preconditioner).

The 50/50 blend of dried distiller's grains/ground soy was introduced through the precondition (Model 2599) that is mounted on Model 2500 Extruder.

Steam Pressure used: 15-20 P.S.I.

Pre-conditioner Temperature: 171° F.

Extruder Barrel Configuration: Single flight screws with 11R-11R-11R-11 steam locks.

Shaping Attachment: Nose cone size 7/16 inch.

Extruder temperature at the last chamber=288° F.

Production rate: 5160 lbs. per hour.

Moisture content of extruded 50/50 dried distiller's grains/soybeans=7%.

3. Extrusion of Partially Dried Distillers Grains. The partially dried distiller's grains with solubles are processed using dry extrusion so as to not add additional moisture from the preconditioner. The partially dried distillers grains with solubles are dried to 25% to 35% moisture. The partially dried distillers grains with solubles are blended at 50/50 with ground soybeans, whereupon the moisture content of the blend is between about 18% and about 22%. The blend was processed in a Model 9400 Extruder.

Extruder Barrel Configuration: Double flight screws with 8-8-8-8-8 steam locks.

Shaping Attachment: Nose cone size ⅞ inch.

Extruder temperature at the last chamber=320-360° F.

Production rate: 7000-8000 lbs. per hour.

Moisture of extruded product: 10%-12%.

Table 1 compares the complete analysis of the dried distiller's grains/soybeans to the conventional dried distiller's grains, dried distiller's grains solubles, and corn distiller's solubles.

TABLE 1
Comparative nutrient composition of co-products
from corn dry milling fermentation
and products of present invention

| | | dried | | | dried |
|---|---|---|---|---|---|
| | | distiller's | dried | corn | distiller's |
| | | grains | distiller's | distiller's | grains/ |
| Nutrient | Unit | solubles | grains | solubles | soybean |
| Dry matter | % | 90.00 | 90.00 | 100.00 | 90.00 |
| Protein | % | 25.00 | 27.00 | 28.50 | 32.00 |
| Fat | % | 8.00 | 7.60 | 9.00 | 12.00 |
| Fiber | % | 9.10 | 13.00 | 4.00 | 4.00 |
| NDF | % | 44.00 | 44.00 | 23.00 | 32.00 |
| ADF | % | 18.00 | 18.00 | 7.00 | 13.00 |
| Ash | % | 5.00 | 3.00 | 7.40 | 6.00 |
| Lysine | % | 0.70 | 0.50 | 0.90 | 1.50 |
| Methionine | % | 0.60 | 0.20 | 1.50 | 0.55 |
| Cystine | % | 0.30 | 0.20 | 0.40 | 0.47 |
| Arginine | % | 1.05 | 0.60 | 1.00 | 1.85 |
| Theonine | % | 0.93 | 0.82 | 0.98 | 1.25 |
| Valine | % | 1.63 | 1.20 | 1.60 | 1.65 |
| Isoleucine | % | 1.52 | 0.93 | 1.20 | 1.52 |
| Tryptophan | % | 0.20 | 0.20 | 0.30 | 0.35 |
| Linoleic | % | 3.90 | 3.60 | 4.40 | 5.25 |
| Acid | | | | | |
| By-pass | % | 38.00 | 38.00 | n/a | 55.00 |
| Protein | | | | | |
| TDN | % | 85.00 | 77.00 | 74.00 | 85.00 |
| NE-L | mcal/lb | 0.92 | 0.99 | 0.89 | 1.00 |
| NE-G | mcal/lb | 0.68 | 0.67 | 0.60 | 0.75 |
| NE-M | mcal/lb | 0.99 | 0.89 | 0.85 | 1.00 |
| ME-Swine | kcal/lb | 1540.00 | 1005.00 | 1540.00 | 1590.00 |
| ME-Poultry | kcal/lb | 1250.00 | 940.00 | 1250.00 | 1475.00 |
| DE-Horse | kcal/lb | 1586.00 | n/a | n/a | 1590 |
| NSC | % | 15.00 | n/a | n/a | 22.00 |
| Phosphorus | % | 0.71 | 0.37 | 1.30 | 0.65 |
| Potassium | % | 0.44 | 0.16 | 1.75 | 1.10 |
| Calcium | % | 0.15 | 0.10 | 0.30 | 0.25 |
| Magnesium | % | 0.18 | 0.07 | 0.65 | 0.22 |
| Sodium | % | 0.57 | 0.90 | 0.30 | 0.25 |
| Sulfur | % | 0.33 | 0.43 | 0.37 | 0.25 |
| Iron | ppm | 223.00 | 200.00 | 600.00 | 160.00 |
| Copper | ppm | 58.00 | 44.00 | 83.00 | 35.00 |
| Manganese | ppm | 25.00 | n/a | n/a | 28.00 |
| Cobalt | ppm | 0.18 | n/a | n/a | 0.13 |

It is evident from the comparison that most of the nutrient levels, particularly crude protein, amino acids and fiber content of the dried distiller's grains/soybean, is superior to that of the conventional products. The lower crude fiber content and higher amino acid level allows for the practical inclusion of this product into all animal species including monogastric animals thus creating a new and larger market for the original DDG and dried distiller's grains solubles. Several in-house feeding trials being conducted on swine grower-finisher utilizing 10-20% of the diet as dried distiller's grains/soybean. In the on-farm acceptance trial conducted in northern Iowa, pigs fed the 50/50 extruded blend of dried distiller's grains with solubles and ground soybean meal performed as well as a control group of pigs.

### EXAMPLE 2

### Swine Palatability Trial on Dried Distiller's Grains Solubles/Soybean

A feeder pig grower ration utilizing corn (74.5%), ExPress® soybean meal (15.5%) dried distiller's grains solubles/soybean (10%), and a vitamin mineral premix was prepared. The ingredients were mixed in an animal feed mixer and fed to a group of 20 head of swine, selected as the poorest performers out of a group of 75 head, having an approximate body weight was 120 lbs. per pig.

The general odor of the complete feed was desirable, the flowability was excellent, the palatability was excellent, and the feed intake was excellent. After a 3-week period on this ration, the pigs were observed to gaining and blooming very well.

### EXAMPLE 3

### Swine Acceptance Trial

Diets were formulated for gilts and barrows to include the use of co-extruded DDGS and soybeans, produced as described above under Example 1(1), as a replacement for soybean meal and animal fat in a control diet. Five growth phase diets were formulated on an equal calculated metabolizable energy, and lysine levels as compared with the control diets. Four pens were used. Gilts and barrows were fed separately (two pens/treatment). Seventy-nine gilts (pen 1) and 96 barrows (pen 3) were fed diets including the animal feed product of the present invention. Eighty-four gilts (pen 2) and 96 barrows (pen 4) were fed control diets.

TABLE 2
Calculated Analysis for Gilt Rations

| | | | | | |
|---|---|---|---|---|---|
| Wt. (lbs) | 45-90 | 90-130 | 130-170 | 170-200 | 200-250 |
| ME. Kcal/lb | 1581 | 1584 | 1569 | 1540 | 1540 |
| Crude Protein | 19 | 16.3 | 15.1 | 13.8 | 12.2 |
| Lysine % | 1.14 | 0.92 | 0.83 | 0.72 | 0.60 |
| Threonine % | 0.76 | 0.65 | 0.60 | 0.54 | 0.49 |

TABLE 3
Calculated Analysis for Barrow Rations

| | | | | | |
|---|---|---|---|---|---|
| Wt. (lbs) | 45-90 | 90-130 | 130-170 | 170-200 | 200-250 |
| ME. Kcal/lb | 1581 | 1565 | 1540 | 1540 | 1540 |
| Crude Protein % | 19 | 15.40 | 14.00 | 12.65 | 11.40 |
| Lysine % | 1.14 | 0.85 | 0.74 | 0.63 | 0.55 |
| Threonine % | 0.76 | 0.61 | 0.55 | 0.50 | 0.45 |

Extra choice white grease was added to the control diets to equalize the calculated ME value of the experimental ingredient-based diets.

TABLE 4
Percent Ingredient Replacement by Experimental
Ingredient - Gilt Rations

| | | | | | |
|---|---|---|---|---|---|
| Ingredients | 45-90 | 90-130 | 130-170 | 170-200 | 200-250 |
| SBM 48% | 34 | 43.3 | 53.7 | 73.7 | 100 |
| Animal Fat | 37.5 | 37.5 | 50.0 | 100 | 100 |
| DDGS | 100 | 100 | 100 | 100 | 100 |
| % XDS plus in | 20 | 20 | 20 | 20 | 20 |
| diet | | | | | |

TABLE 5
Ingredient Replacement by Experimental
Ingredient - Barrow Rations

| | | | | | |
|---|---|---|---|---|---|
| Ingredients | 45-90 | 90-130 | 130-170 | 170-200 | 200-250 |
| SBM 48% | 34 | 50.9 | 70.7 | 100 | 100 |
| Animal Fat | 37.5 | 50.0 | 100 | 100 | 100 |
| DDGS | 100 | 100 | 100 | 100 | 100 |
| % XDS plus in | 20 | 20 | 20 | 18.75 | 18.75 |
| diet | | | | | |

TABLE 6
Results of Feeding Trial

| | Experimental | | | |
|---|---|---|---|---|
| | Ration | | Control | |
| | Gilts | Barrows | Gilts | Barrows |
| Ave. Starting Wt. (lbs) | 49.62 | 55.83 | 61.19 | 57.08 |
| Ave. Finishing Wt. (lbs.) | 252.05 | 253.01 | 263.00 | 261.70 |
| Ave. Gain/Pig (lbs.) | 202.43 | 197.18 | 201.81 | 204.62 |
| Ave. Daily Gain (lbs.) | 1.46 | 1.41 | 1.43 | 1.46 |
| Feed per Pig/Daily (lbs.) | 4.91 | 5.30 | 5.13 | 4.89 |
| Feed/Gain | 3.36 | 3.76 | 3.59 | 3.53 |

| | | |
|---|---|---|
| Per treatment | 3.56 | 3.56 |

From the results of the trial, it can be seen that the pigs fed the experimental ration performed as well as the control group. It is believed that optimizing the processing conditions based on amino acid digestibility will further enhance the performance and that incorporating the maximum amount of solubles may result in an improved feed product.

Although the invention has been described with respect to a preferred embodiment thereof, it is to be also understood that it is not to be so limited since changes and modifications can be made therein which are within the full intended scope of this invention as defined by the appended claims.

I claim:

1. A process for preparing an animal feed, comprising the steps of:
(a) combining a coproduct of dry corn milling with an additive that improves the amino acid profile of the coproduct, has a fiber content below that of the coproduct, and increased the bioavailability of the feed value of the coproduct in monogastric and ruminant animal, wherein the additive is used in an amount between about 33% and about 300% by weight of the coproduct;
(b) processing the additive and coproduct mixture in an extruder at a temperature between about 200° F. and about 375 ° F.;
(c) flashing off moisture upon expulsion of the feed from the extruder; and
(d) allowing the feed to cool to approximately ambient temperature.

2. A process as defined in claim 1, wherein the moisture content of the additive and coproduct mixture prior to processing in the extruder is between about 7% and about 30% by weight.

3. A process as defined in claim 1, wherein the additive is selected from the group comprising oilseeds and byproducts of oilseeds, legumes and byproducts of legumes, byproducts of cereal grains, and animal byproducts.

4. A process as defined in claim 1, wherein the additive is selected from the group comprising soybeans, rapeseed, cotton seed, palm kernels, flaxseed, linseed, sunflower seed, soybean meal, cottonseed meal, expelled soybean meal, corn gluten meal, fish meal, poultry byproduct meal, meat and bone meal, and feather meal.

5. A process as defined in claim 1, wherein the moisture content of the feed product after cooling is between about 5% and about 12% by weight.

6. An animal feed product comprising, a feed produced by the process of claim 1.

7. An animal feed as defined in claim 6, wherein the feed is added to a ration for monogastric animals in an amount between about 1% and about 35% by weight.

8. An animal feed as defined in claim 6, wherein the feed is added to a ration for ruminant animals in an amount between about 1% and about 25% by weight.

9. An animal feed product as defined in claim 6 where its nutritional profile is superior to dried distiller's grains or dried distiller's grains with solubles and can partially or totally replace a vegetable or animal protein ingredient and fat in ruminant or monogastric animal feed.
